(19) United States
(12) Patent Application Publication
(10) Pub. No.: US 2008/0268410 A1
(43) Pub. Date: Oct. 30, 2008

(54) Method and apparatus for teaching students to hold their breath

(76) Inventor: Ed Pemberton, Knoxville, KY (US)

Correspondence Address: R. Christian Macke, 40 East 10th Street, Newport, KY, 41071, US

(21) Appl. No.: 11/796,922

(22) Filed: Apr. 30, 2007

(51) Int. Cl. A63B 69/12; B05D 1/30

(52) U.S. Cl. 434/254; 239/37

(57) ABSTRACT

A method and apparatus for teaching new swimmers to hold their breath. An apparatus comprising a modified bucket is provided that is first used to drip water onto the head of a swimming student as a warning that more water is going to be dumped onto his head. Next the apparatus is used to dump a sufficient amount of water onto the student's head to trigger breath holding by the student. In the related method, a swimming instructor then quickly dunks the student underwater to teach the student to use and control the reflexive breath holding. For infants, the apparatus and method rely upon the breath holding reflex acquired in the womb to trigger breath holding. By repeating these steps a number of times new swimmers can learn to hold their breath when they go under water.

### FIELD OF THE INVENTION

This invention relates to a method and apparatus used in teaching adults and small children, including infants, to hold their breath when learning to go underwater.

### BACKGROUND OF THE INVENTION

One of the most popular recreations for people of all ages and children in particular is swimming. In fact, it is such a common past-time that swimming pools, including large public facilities and water parks down to private residences, can be found in every neighborhood, often on every block. The omnipresence of swimming pools is reflective of the popularity of swimming as a past-time, but it also presents one of the biggest downsides of swimming, the danger posed by swimming pools to those who cannot swim, specifically and particularly small children that may find their way into the swimming pool without any supervision. The elaborate lengths that pool owners and operators go to to keep untrained swimmers, particularly children, out of the pool, such as fencing, surface tension detectors, splash detectors, etc., reflect the dangers posed by swimming pools. Nonetheless, because swimming is so popular as leisure activity, swimming pools are considered worth the risk that they present.

Thus it has long been recognized that learning to swim is an important skill to acquire for children and adults. The need for children, in particular, to learn to swim at as young an age as possible is recognized by every parent or adult that has read or seen a story about a small child drowning in a backyard swimming pool. Swimming is an important survival skill that is taught in a multitude of ways around the United States.

In swim instruction, one of the first and fundamental skills is for the student, whether adult, child or infant, to learn to hold his breath when he goes underwater. Until the student learns to hold his breath, it is not possible to teach him how to swim strokes or even how to tread water. Because of the importance of the skill, the methods and devices used to teach students how to hold their breath within the instruction of swimming have wide appeal.

Swim instruction for adults, children and infants begins with, first, taking the student and acclimating him to the water. During this acclimation the student is either led into the water by an instructor to a depth at which can easily stand and keep his head above water or, for very small children and infants, the student is securely held, partially submerged, by the instructor. Next, the student is taught to hold his breath when he goes underwater. It can be a challenging and frustrating first task for adults, children and infants alike, but it is particularly difficult with small children and infants that are too young to take direction or understand commands. However, there is an opportunity to take advantage of an instinctive breath holding reflex used in the womb in teaching this skill to infants up to the age of about 6 months old. If an infant is not taught to hold his breath and go underwater by the age of 1, and swim lessons are put off until the age of four, five, six or later, a golden opportunity to teach the first lessons, particularly of learning to hold their breath using the breath holding reflex acquired in the womb which is gone at the age of 6 months, will have been missed.

Humans are born with the instinctive, reflexive capability to hold their breath when properly triggered to do so. Harnessing this breath holding reflex used in the womb which only lasts until about the age of 6 months, can be tremendously valuable as the first step in learning to swim, specifically learning to hold one's breath when he goes underwater. However, the opportunity to utilize the breath holding reflex acquired in the womb is temporary and, unfortunately, not recognized by many parents until it is too late.

In addition to the breath holding reflex acquired in the womb that is gone by the age of six months, humans are also equipped with another breath holding reflex, the mammalian diving response which has been exhaustively researched at Lund University in Sweden. The mammalian diving response is the reaction triggered in mammals during immersion in water. It is a dual action of the sympathetic and parasympathetic nervous systems that causes the pulse to slow, to use less oxygen, and the peripheral blood vessels to constrict, to reserve the blood supply for the brain, heart and lungs. It has been discovered that humans can harness the mammalian diving response to achieve greater diving ability. For example, a trained human has a diving response equivalent to a beaver, while an untrained human has a diving response equivalent to a pig.

In addition, the present inventor has found, through his education and experience with various swim instruction techniques that the breath holding reflex acquired in the womb only exists in infants up to the age of about 6 months old. In addition, the harnessing of the mammalian diving response gives a continued opportunity to utilize a human reflex to teach a beginning swimmer to hold their breath when he goes underwater, although the opportunity to use the stronger breath holding reflex acquired in the womb will have been missed if not harnessed by the age of six months.

Through the application various techniques and methods of swim instruction, and by applying his education and experience, the current inventor has learned that the breath holding reflex acquired in the womb and the mammalian diving response act of holding one's breath can be triggered by immersion in cold water or by blowing into the face of a small child. Prior art swim instruction techniques have used blowing in the face as the triggering mechanism to cause a child to hold his breath, but that technique is disadvantageous for several reasons. First, triggering the instinctive breath holding reflex acquired in the womb or the mammalian diving response with a gust of air is a response to a different stimulation than exposure to water and not the same as the desired outcome, i.e. holding breath to go underwater. Secondly, because the breath holding reflex acquired in the womb is gone after the age of about six months old, blowing into the face of an adult or older child does not necessarily or as strongly trigger an instinctive breath holding response, and the present invention seeks to provided a method and apparatus to teach novice swimmers to hold their breath, whether they are adults, children or infants. In addition, it has been the inventor's experience that a small child or infant being blown in the face will often be upset by such stimulation and will lose trust in the parent or instructor doing so, frustrating the process of learning. If blowing in the face does not trigger the breath holding reflex acquired in the womb or the mammalian diving response in the student of holding his breath, then when the child goes underwater and swallows water and coughs or chokes, the objective of getting the child to hold his breath to go underwater will have taken a big step backward.

The present apparatus and method improve the instruction of small children and infants to hold their breath by providing a multiple step method and apparatus particularly well suited therefor. As will be set forth in more detail herein, the present invention provides a method and apparatus that warns the child that the breath holding reflex or mammalian diving response is going to be triggered, then triggers it with exposure to water, followed immediately by dunking the child underwater while he is still holding his breath. Pouring water over the student's head prior to dunking him underwater makes the student aware that they are about to go underwater, and they hold their breath, either voluntarily or, as the inventor, has found, involuntarily and instinctively for infants possessing the breath holding reflex acquired in the womb and, to a lesser degree for older children and adults, through the harnessing of the mammalian diving response. For all ages, if the breath holding is not successful, the student will choke on the water dumped and will not be submerged. It will be less traumatic to the student in that manner and, thus, easier to continue to move forward with breath holding and swim instruction.

### OBJECTS OF THE INVENTION

It is an object of the present invention to provide an improved apparatus used in teaching adults, small children and infants to hold their breath when going underwater.

It is another object of the present invention to provide an apparatus capitalizing on the temporary presence of the breath holding reflex acquired in the womb in infants to teach them to hold their breath when going underwater.

It is yet another object of the present invention to provide a warning to small children and infants that the breath holding reflex acquired in the womb and the mammalian diving response is going to be triggered.

It is a further object of the present invention to provide an apparatus that can be used in a multiple step process teaching adults, children and infants to hold their breath when going underwater.

It is a further object of the present invention to provide an apparatus having provisions for imparting water in a first trickle amount onto the student's head followed by a gush of water triggering the breath holding reflex acquired in the womb and the mammalian diving response.

It is yet another object of the present invention to provide an apparatus with provisions for being held with one hand by a swim instructor while an infant being taught to hold his breath to go underwater is held in the other hand.

It is another object of the present invention to provide a method for teaching adults, children and infants to hold their breath by providing a warning event to trigger the student holding his breath prior to being submerged underwater, whether such breath holding is voluntary in adults or older children or involuntary and instinctive, such as with infants possessing the breath holding reflex acquired in the womb and with older children and adults possessing the mammalian diving response.

It is another object of the present invention to provide a method for teaching an adult, child or infant to go underwater utilizing the breath holding reflex acquired in the womb and the mammalian diving response.

It is yet another object of the present invention to provide a method of teaching an infant or small child to hold his breath to go underwater comprising multiple steps of trickling water onto the student's head as a warning, then dumping water onto the student's head to trigger the breath holding reflex acquired in the womb or the mammalian diving response, then dunking the child underwater and successively repeating until the student holds this breath underwater for an extended period of time.

These and other objects and advantages of the present invention will be apparent from a review of the following specification and accompanying drawings.

### SUMMARY OF THE INVENTION

The present invention provides an apparatus used to teach a swimming student the most fundamental skill in learning to swim, that of holding his breath. The inventive apparatus comprises a fluid retaining receptacle, a first means for slowly releasing fluid retained in the receptacle, and a second means for dumping fluid retained in the receptacle over the head of the swimming student. By applying the apparatus in this manner, breath holding by the student is triggered.

In one application of the present invention, the apparatus is utilized with a swimming student that is an infant such that the use of the second means for dumping the fluid retained in the receptacle triggers the breath holding reflex acquired in the womb or the mammalian diving response in the infant.

The fluid retaining receptacle of the present invention comprises a unitary receptacle wherein the first means built into the receptacle for slowly releasing the fluid therein comprises pinholes formed in the bottom of the receptacle. It is also specifically contemplated, without limitation, that the first means may also comprise a fine mesh screen without departing from the principles of the present invention.

The present invention also comprises a method for teaching a swimming student to hold his breath when going under water. The inventive method comprises the steps of the instructor holding the student in one hand while standing in a swimming pool. A fluid retaining receptacle is provided that has a first means for slowly releasing fluid retained in it and a second means for dumping fluid retained in it.

The next step in the inventive method is the instructor dunking the receptacle into the swimming pool to fill it up. The instructor then holds the receptacle over the head of the student such that water trickles out of the receptacle and onto his head. Next, the instructor dumps the water remaining in the receptacle over the student's head to trigger breath holding by the student. Immediately after dumping the receptacle onto the student's head, and while the student is still holding his breath, the instructor dunks the student under water.

The preferred embodiment of the inventive method provides that the swimming student comprises an infant and the breath holding triggered by the dumping of the water from the receptacle onto the infant comprises the breath holding reflex acquired in the womb by the infant.

### BRIEF DESCRIPTION OF THE DRAWINGS

FIG. 1 is a perspective view of the bucket of the present invention.

FIG. 2A is a drawing depicting a swim instructor holding a small child during the first trickling step of the method of the present invention.

FIG. 2B is a drawing depicting a swim instructor holding a small child during the dumping/breath holding triggering step of the present invention.

FIG. 2C is a drawing depicting a swim instructor holding a small child and dunking the child underwater in accordance with the principles of the present invention.

### DETAILED DESCRIPTION OF THE INVENTION

It is a fundamental goal of the present invention to provide an apparatus and method for teaching adults, small children and infants to learn to hold their breath as a first step of learning to swim. In particular, it provides an apparatus and method that can be used with adults to decrease the trauma of unsuccessfully holding their breath. That is, the adult or older child will swallow less water and choke less severely when attempting to hold their breath if it is dumped from a small receptacle than if they go underwater.

Humans are born with two breath holding instincts, the breath holding reflex acquired in the womb and the mammalian diving response. Both instincts cause them to reflexively hold their breath when properly triggered. The mammalian diving response which has been exhaustively researched at Lund University in Sweden is the reaction triggered in mammals during immersion in water. It is a dual action of the sympathetic and parasympathetic nervous systems that causes the pulse to slow, to use less oxygen, and the peripheral blood vessels to constrict, to reserve the blood supply for the brain, heart and lungs. It has been discovered that humans can harness the mammalian diving response to achieve greater diving ability. For example, a trained human has a diving response equivalent to a beaver, while an untrained human has a diving response equivalent to a pig.

With respect to the breath holding reflex acquired in the womb, the present inventor has found, through his education and experience with various swim instruction techniques the breath holding reflex acquired in the womb is gone by the age of 6 months while the less pronounced mammalian diving response exists in children and adults.

The present invention provides a safe and non-traumatic trigger for the student to hold his breath, whether he is doing so voluntarily or instinctively with the breath holding reflex acquired in the womb or the mammalian diving response. Once breath holding is achieved, subsequent steps to teach adults, children or infants to swim is undertaken.

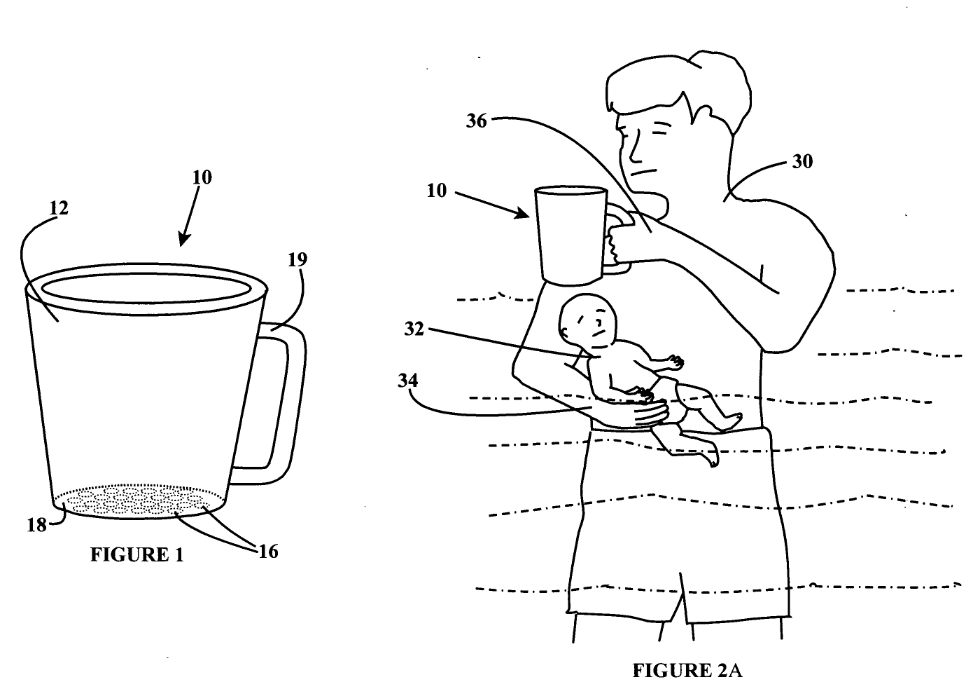

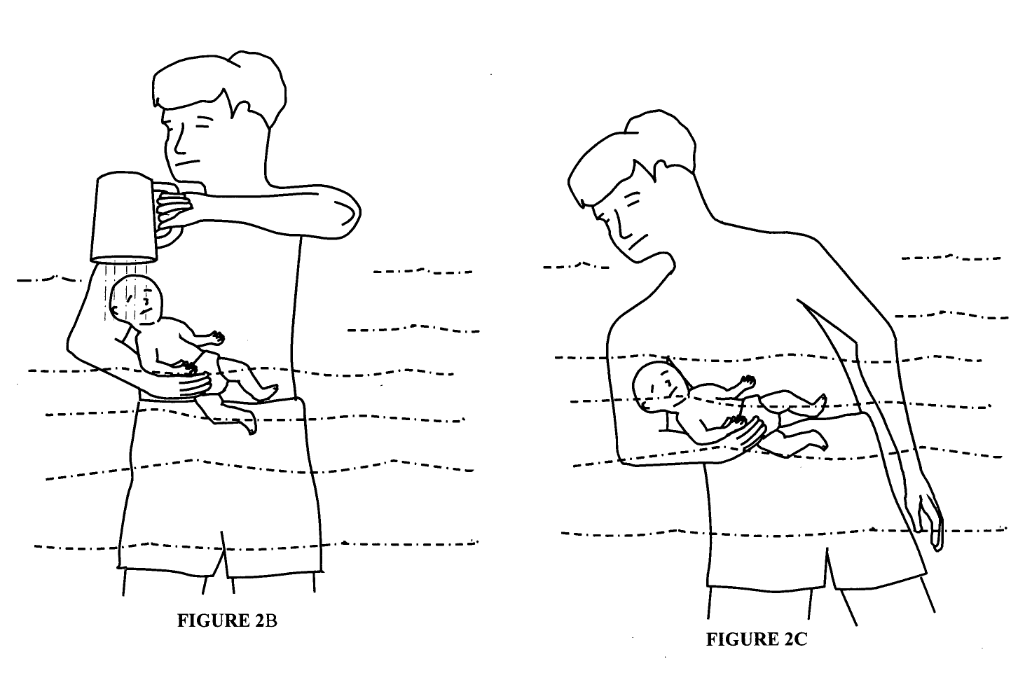

FIG. 1 depicts a preferred embodiment of the present invention. Bucket 10 comprises an essentially cylindrical receptacle 12 having a bottom 18. The receptacle 12 is appropriately sized to substantially retain a sufficient amount of fluid 14 therein, such as water, such that when it is dumped over the head of the student the reaction to hold one's breath is triggered, either voluntarily for adults and older children or involuntarily for infants possessing the breath holding reflex acquired in the womb and for older children or adults strongly possessing the mammalian diving response. The bucket 10 is designed and sized so that a swim instructor can easily manipulate the bucket 10 with one hand while holding a child with the other hand (FIGS. 2A-2C). It is specifically contemplated that that the receptacle 12 may be designed with a grip or handle for ease of holding without departing from the principles of the present invention.

Small perforations 16 in the bottom 18 of the receptacle 12 provide a means for slowly releasing fluid retained in the receptacle 12 out of the bottom 18. The perforations 16 are sufficiently small so that most of the water 14 is retained in the bucket 10, essentially allowing just a drip trickle through the perforations 16 as long as the bucket 10 is held upright.

In one preferred embodiment of the present invention, the perforations 16 comprise small pin holes formed in the bottom 18 of a unitary plastic receptacle 12 formed, for example, in an injection molded plastic extrusion process. In a second embodiment, the perforations 16 and bottom 18 may be formed from other processes and materials and all such embodiments are contemplated and do not depart from the principles of the present invention. In addition, other embodiments allowing water retained in the bucket 10 to trickle out are specifically contemplated and do not depart from the principles of the present invention.

The bucket 10 is utilized as depicted in FIGS. 2A-2C by an instructor 30 teaching a student 32 to hold his breath. In a first step the instructor 30 holds the student 32 with one hand 34 while holding the bucket 10 with the other hand 36. While standing in a pool, the instructor 30 dunks the bucket 10 into the pool water 38 such that it is essentially full, then holds it over the head of the student 32 as shown in FIG. 2A. Water trickles out the bottom 18 through the perforations 16 of the bucket 10 as shown to provide a warning to the child 32 that a water dump is about to occur. The bucket 10 is appropriately sized such that it can be gripped with one hand and, in a preferred embodiment of the present invention, includes a gripping means provided by a handle 19. The handle 19 as depicted is a continuous length of material connected to the bucket 10 at both ends and formed as part of the unitary injection mold process from which the bucket 10 is formed, but other handles or gripping means allowing an instructor to easily control and manipulate the bucket 10 with one hand are specifically contemplated and do not depart from the principles of the present invention.

In the second step, depicted in FIG. 2B, the instructor 30 has upended the bucket 10 and dumped the contents 40 onto the head of the student 32, thereby triggering the student 32 to hold his breath, either voluntarily if he is an adult or older child or instinctively if the student 32 is an infant possessed of the breath holding reflex acquired in the womb or of the mammalian diving response. While the most preferred embodiment reflects a simple bucket that is simply upended to dump the water contained therein, other provisions for releasing the water from the receptacle 12 such as a trigger releasable or latching bottom or side are specifically contemplated and do not depart from the principles of the present invention.

In the third step, immediately after dumping the water from the receptacle 12 onto the student's head, and if the student 32 has held his breath and not choked from the water dumped on his head, the instructor dunks the student 32 underwater. In this way, the student is conditioned to hold his breath prior to being dunked underwater. After repeated cycles, the child 32 is able to hold his breath for longer periods of time, and one of the major hurdles in learning to swim, learning to hold his breath when going underwater, is cleared.

The receptacle 12 is particularly useful in teaching infants and very small children to hold their breath because it includes a first means for slowly releasing water contained therein and a second means for dumping water retained in the receptacle 12 over the head of an infant to trigger the infant to hold his breath. This is done instinctively if the infant is still possessed of the breath holding reflex acquired in the womb or of the mammalian diving response. In the most preferred embodiment of the present invention, the first means comprises perforations 16 in the bottom 18 of the receptacle 12 that allows water to escape at a drip rate. Other means for slowly releasing the water such as, without limitation, a very fine mesh screen, are contemplated and do not depart from the principles of the present invention.

In the most preferred embodiment of the present invention, the second means for dumping water is provided by a receptacle that is gripped with one hand and easily manipulated to release the contents contained therein. It is specifically contemplated that the alternative embodiments for the second means comprise a receptacle 12 having a handle 19 and a receptacle having a latching, trigger released bottom or side that is released to dump the contents contained therein.

In accordance with the principles of the present invention there is also provided a related method in which multiple steps are utilized in the teaching of beginning swimmers to hold their breath, to allow them to go underwater at a very young age.

The first step of the inventive method is that of the instructor 30 holding and supporting the student 32 in a first hand 34 such that the student's head is safely above water. The student's body 32 is partially submerged during the first step to allow the student to get acclimated to the water.

A necessary implement for several steps in the inventive method is a bucket 10 having first means for slowly releasing water retained in the receptacle 12, this first means being provided by perforations 16 in the bottom 18. The bucket 10 is held by the instructor 30 in one hand 36 opposite to the hand holding and supporting the student 32. The bucket 10 also has a second means for dumping the fluid retained therein on the head of the student 32.

The next step of the inventive method is dunking the bucket 10 into the pool water to essentially fill it up so that, when it is raised out of the pool water, a trickle of water escapes through the firs means perforations 16. Quickly, before too much water is lost through the perforations 18, the. instructor raises the bucket 10 above the head of the student 32 so that the trickle falls upon the student's head. After several uses of the inventive method, the student 32 learns to recognize the trickling of water on his head as a warning that a water dump triggering him to hold his breath is impending.

The next step in the inventive method is dumping the water in the bucket 10 over the head of the student 32, which triggers the student to hold his breath. In adults and older children, the breath holding is voluntary and intentional after the dump of the water while for infants the dump of the water triggers the breath holding reflex acquired in the womb and the mammalian diving response.

After dumping the water onto the student, if the student successfully held his breath and is not choking or coughing from the water dumped on his head, the instructor then quickly effects the next step in the inventive method of dunking the student 32 underwater immediately after the breath holding by the student is triggered. The student 32 quickly learns that it is necessary for survival to hold his breath underwater, and with repeated applications the student 32 will be able to hold his breath for longer and longer periods of time.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

I claim:

1. An apparatus used to teach a student to hold his breath comprising:
a fluid retaining receptacle;
first means for slowly releasing fluid retained in said receptacle;
second means for dumping fluid retained in said receptacle over the head of said student to trigger said student to hold his breath.

2. The apparatus set forth in claim 1 wherein said student is an infant and said second means for dumping triggers a breath holding reflex acquired in the womb by said infant.

3. The apparatus as set forth in claim 1 wherein said fluid retaining receptacle comprises a unitary receptacle and said first means for slowly releasing comprises pinholes formed in a bottom of said unitary receptacle.

4. The apparatus as set forth in claim 1 wherein said first means for slowly releasing fluid comprises a fine mesh screen.

5. A method for teaching a student to hold his breath when going under water comprising the steps of:
Holding said student in one hand while standing in a swimming pool;
Providing a fluid retaining receptacle having a first means for slowly releasing fluid retained in said receptacle and a second means for dumping fluid retained in said receptacle;
Dunking said receptacle into the swimming pool to fill it up;
Holding the receptacle over the head of said student such that water trickles out of the receptacle and onto said student's head;
Dumping the water remaining in the receptacle over said student's head to trigger breath holding by said student; and
Immediately dunking said student under water while he is still holding his breath.

6. The method set forth in claim 5 wherein said student comprises an infant and said breath holding by said student comprises a breath holding reflex acquired in the womb by said infant.
